(19) United States
(12) Patent Application Publication
(10) Pub. No.: US 2013/0134350 A1
(43) Pub. Date: May 30, 2013

(54) STABILIZED ORGANOMETALLIC REAGENTS

(71) Applicant: Reuben Rieke, Lincoln, NE (US)

(72) Inventor: Reuben Rieke, Lincoln, NE (US)

(73) Assignee: RIEKE METALS INC., Lincoln, NE (US)

(21) Appl. No.: 13/634,960

(22) PCT Filed: Mar. 15, 2011
(86) PCT No.: PCT/US11/28474

§ 371 Date: Jan. 2, 2013

(30) Foreign Application Priority Data
Mar. 16, 2010 (US) 61314291

(51) Int. Cl. C09K 3/00

(52) U.S. Cl. CPC C09K 3/00
USPC 252/182.29

(57) ABSTRACT

Compositions of stabilized forms of organometallic reagents, methods of preparing the stabilized forms, and methods of using the stabilized forms, are provided. Stabilized organometallic reagent compositions of the invention are sorbent solids permeated by the organometallic reagent. The reagent can be a Grignard reagent, a Reformatsky reagent, a zinc reagent of the type RZnX, R₂Zn, Ar₂Zn, R₃ZnM, Ar₃ZnM, and the like, an organolithium reagent such as n-butyllithium, a organocopper reagent, or other reactive, potentially pyrophoric reagent. The compositions are solids that can be weighed and dispensed in ambient air without requiring inert gas blanketing. The compositions can be prepared by contacting the sorbent solid, which can be silica, an alkyl silica, alumina, or other non-reactive sorbent solid with a solution of the organometallic reagent in a non-reactive solvent, then, removing the solvent, such as under vacuum. The stabilized composition can be used by extracting the organometallic reagent from the composition with a non-reactive solvent and contacting the solution with a reactant.

### CROSS-REFERENCE TO RELATED APPLICATIONS

This application claims the priority of U.S. provisional application Ser. No. 61/314,291, filed Mar. 16, 2010, which is incorporated herein by reference in its entirety.

### BACKGROUND

A wide variety of organometallic compounds find use in organic synthesis as strong bases and as nucleophilic reagents. Organomagnesium compounds such as Grignard reagents have been known for over 100 years, and provide a versatile approach to the formation of carbon-carbon bonds by reaction with electrophiles such as carbonyl compounds, e.g., ketones and the like. Organozinc zinc compounds such as Reformatsky reagents find great use in synthesis of complex structures, allowing for the presence of a wide variety of functional groups such as esters, ketones, nitriles, ethers, and others in the organometal compound. Organolithium compounds such as n-butyllithium and lithium dialkylamides are used predominantly as strong bases, capable of abstracting an acidic proton from weakly activated positions, such as protons adjacent to carbonyl or sulfonyl groups.

However, most organometallic reagents are highly reactive, unstable in the presence of water or oxygen, available only in solution, and dangerous to handle due to their pyrophoric properties. As the reagents are commercially available almost exclusively in solution, and the solutions are often unstable over time, tedious titrations to determine the actual strength of the organometallic reagent in the solution are required for accurate measurement of defined quantities such as are needed in organic synthesis, at any scale.

### SUMMARY

The present invention is directed, in various embodiments, to stabilized compositions of organometallic reagents, to methods of preparing the stabilized organometallic compositions, and to methods of using the stabilized organometallic compositions.

In various embodiments, the invention provides stabilized organometallic reagent compositions comprising a non-reactive sorbent solid permeated with an organometallic compound. The composition can further comprise a non-reactive solvent in which the organometallic compound is soluble.

In various embodiments, the invention provides a method of preparation of the stabilized organometallic compositions of the invention, comprising contacting the sorbent solid with a solution of the organometallic compound in a second non-reactive solvent, then, removing the solvent. Optionally, a non-reactive solvent which can be different from the second non-reactive solvent can be added to the solid bearing the organometallic reagent.

In various embodiments, the invention provides a method of using the stabilized organometallic composition of the invention, or a stabilized organometallic composition prepared by a method of the invention, comprising contacting the composition with one or more reactants, optionally in a third non-reactive solvent, such that the organometallic compound undergoes a chemical reaction with the one or more reactants to yield a reaction product.

### DETAILED DESCRIPTION

### Definitions

As used in the specification and the appended claims, the singular forms “a,” “an” and “the” include plural referents unless the context clearly dictates otherwise.

The term “about” as used herein, when referring to a numerical value or range, allows for a degree of variability in the value or range, for example, within 10%, or within 5% of a stated value or of a stated limit of a range.

“Substantially” as the term is used herein means completely or almost completely; for example, a composition that is “substantially free” of a component either has none of the component or contains such a trace amount that any relevant functional property of the composition is unaffected by the presence of the trace amount, or a compound is “substantially pure” is there are only negligible traces of impurities present.

The term “organometallic compound” as the term is used herein refers to a chemical composition including both an organic moiety or moieties and at least one metallic element in association. The term includes compounds in which the organic groups are bonded to the metal atom(s) via covalent, ionic, or complexing interactions, or any combination. Examples include organomagneium (Grignard) reagents, organozinc (Reformatsky, dialkylzinc, alkyl zinc halides, trialkyl zincates, diaryl zinc, triaryl zincates, and the like) reagents, organocopper reagents such as dialkylcopperlithium reagents, organolithium reagents such as n-butyllithium or lithium diisopropylamide, and the like.

The term “sorbent solid” as used herein refers to an adsorbent material that can imbibe a liquid, such as silica or alumina, which can be surface modified such as with alkyl groups of various lengths (i.e., C₁, C₂, C₃, . . . C₈, . . . C₁₈, and even longer chains) various forms of carbon such as charcoal or graphite, clays, and the like.

A “stabilized organometallic reagent composition” refers to a composition of the invention wherein an organometallic reagent is present within a sorbent solid, such as within pores of the solid or distributed within the bulk matrix of the solid.

A “non-reactive solvent” as the term is used herein refers to a liquid material that can dissolve an organometallic compound at some concentration, but does not react at a significant rate with the organometallic compound.

A stabilized organometallic reagent composition of the invention is “suitable for handling in air” when any pyrophoric property of an organometallic reagent is reduced by absorption within the sorbent solid such that samples of the stabilized material can be weighed, transferred, etc. without requiring recourse to an inert atmosphere (nitrogen, argon, etc.) to avoid decomposition or spontaneous combustion of the organometallic.

A “pyrophoric” material, as is well known in the art, is a material that can spontaneously burst into flame upon exposure to oxygen, water, or the like as are present in the atmosphere of a laboratory or manufacturing facility. A solution of an organometallic compound can be pyrophoric due to heat released by the reaction of the organometallic with oxygen or moisture, or both, being sufficient to initiate combustion of the organometallic reagent itself or of a solvent that is present in the composition. An example of a material that is regarded as pyrophoric is an organolithium reagent dissolved in a hydrocarbon solvent. Many organometallic reagents are known to be pyrophoric in “ambient air”, that is, air as is normally found in nature, containing some amount of water vapor.

The term “sorption” as used herein refers to adsorption, absorption, or both. A “sorbent” solid is a solid that that adsorbs, absorbs, or both, a liquid. When a sorbent solid is contacted with a solution of an organometallic reagent in a non-reactive solvent, the sorbent solid takes up or imbibes the liquid solution. When the solvent is at least partially removed, the organometallic reagent that remains within the sorbent solid can be adsorbed on the surfaces of pores within the bulk solid, or can be absorbed within the bulk phase of the solid, or both. Within the meaning herein, the solid is thereby “permeated” by the organometallic reagent. The organometallic reagent is distributed substantially uniformly throughout the solid at the macroscopic level, such that the solid can be titrated and/or weighed to indicate loadings of the reagent in the solid (e.g., in mmole/gm of solid) with sufficient reliability to use the material in reactions requiring defined stoichiometry. However, the organometallic reagent is not necessarily uniformly distributed throughout the solid at the molecular level; for example, it can be distributed largely on the walls of interior pores and not within the bulk material, or can be distributed largely within the bulk material and not within the void volume of pores.

### DETAILED DESCRIPTION

In various embodiments, the invention is directed to a stabilized organometallic reagent composition comprising a non-reactive sorbent solid permeated with an organometallic compound. The composition is in physical form a solid, e.g. a powder, that can be weighed and transferred in the normal manner of handling solid chemical reagents. The organometallic compound does not react with the sorbent solid in a chemical manner that produces an irreversible alteration of the organometallic compound. Upon contacting the stabilized composition with a non-reactive solvent, the organometallic reagent can be extracted from the solid into a solution and can react with reactants in a manner typical for that organometallic reagent.

In various embodiments, the organometallic reagent can be present at a loading of about 1 mmole per gram of solid to about 10 mmole per gram of solid. Or, the organometallic reagent can be present at a loading of about 2 mmole per gram of solid to about 4 mmole per gram of solid.

In various embodiments, the sorbent solid can be a porous solid. An example is silica gel. The average pore size, and the average pore volume per unit weight, can be any typical value for the particular material.

In various embodiments, the composition can further comprise a non-reactive solvent in which the organometallic compound is soluble. For example, a method of preparing the composition of the invention, as discussed below, is to contact the sorbent solid with a solution of the organometallic reagent in the non-reactive solvent, which can be followed by at least partial removal of the solvent. Complete removal of the solvent can be carried out, but in various embodiments residual solvent can be present in the inventive composition. In various embodiments, solvent need not be removed at all, provided that there is sufficient solid to bring about complete sorption of the solution. Accordingly, the inventive composition can include a solvent. For example, the solvent can comprise an ether or a hydrocarbon, or any mixture thereof. More specifically, the first non-reactive solvent can be diethyl ether, tetrahydrofuran, 1,4-dioxane, glyme, diglyme, pentane, hexane, octanes, or aryl solvents such as benzene, toluene, ethyl benzene, xylenes, and the like, or any mixture thereof.

In various embodiments, the non-reactive sorbent solid can comprise silica, an alkylated silica, or alumina. For example, the alkylated silica can comprise a C8-silica or a C18-silica. In various embodiments, the solid can be a zeolite or another kind of porous mineral, or a sorbent clay or an organic polymer. With the proper choice of solvent and solid support, reactions of the reagent may occur in the matrix on the surface of the matrix. If the support is chiral, the reaction product can be chiral.

The organometallic reagent can be any such reagent for which stabilization is desired. Typically such reagents are strongly basic due to the anionic nature of the carbon atom(s) bonded to the electropositive metal atom(s). The reagents are also typically potent nucleophiles, due to the electron rich nature of the metal-bonded carbon atom(s). Often, they are prone to react with water, such as atmospheric moisture, or with oxygen, or both, making handling in air problematic. In various embodiments, compositions of the invention and compositions prepared by methods of the invention exhibit a substantially lower reactivity towards such deleterious substances than do the reagents themselves in pure form or even in solution.

Examples of organometallic reagents include an organolithium, organomagnesium, organocopper, or organozinc reagent. For example, the organometallic compound can be a Grignard reagent, a Reformatsky reagent, an alkyl zinc halide reagent, a diaryl zinc, a trialkyl zincate, a triaryl zincate, a dialkylcopperlithium reagent, an alkyl aluminum, n-butyllithium, isobutyllithium, or tert-butyllithium.

As is well known in the art, these reagents are to a greater or lesser degree unstable in the presence of oxygen and/or atmospheric moisture, and require special handling to avoid decomposition or even ignition of the mixtures. Typically, such organometallic reagents are handled in solutions in non-reactive solvents, under inert gas atmosphere (nitrogen, argon, etc.), using syringes, septa, and other equipment adapted to avoid contact of the reagent with ambient air. These limitations on handling make processes using organometallic reagents expensive, cumbersome, and difficult to scale up.

In various embodiments, the stabilized organometallic reagent composition is a particulate material suitable for handling in ambient air. For example, the stabilized organometallic reagent composition of the invention can be less pyrophoric than the organometallic compound in pure form, or in solution.

Many organometallic reagents are only available in a limited number of solvents, e.g., RZnX in THF, Reformatsky in diethyl ether, dialkylzinc reagents in toluene, alkyllithium reagents in tolene and other hydrocarbon solvents. The stabilized organometallic reagents of the invention allow for reactions to be carried out in a solvent of choice regardless of the solvent of the original solution. This can avoid undesired effects that may be caused by the original commercially available solution forms of the reagents.

In addition to a reduced danger from handling, the inventive compositions offer the advantages of handling of relatively stable solids, in that they can be weighed on a balance in open air and transferred without inert gas blanketing or glove box operations, and are sufficiently stable under these conditions that the reactive content of the stabilized composition is not drastically altered; titrations of the active reagent in terms of mmole / gm are accurate for hours, days, or even weeks. While it can be advantageous for long term storage to keep the stabilized forms under anhydrous inert gas atmosphere, at reduced temperatures, or both, loss of activity is slow compared to loss of activity of solutions of the same organometallic reagents held under comparable conditions.

In various embodiments, the invention provides a method of preparation of the composition of the invention, comprising contacting the sorbent solid with a solution of the organometallic compound in a non-reactive solvent, then, removing the solvent. The solid can be contacted with the solution of the organometallic reagent under conditions wherein the solution of the organometallic reagent is relatively stable and where mixing of the solid and liquid can be achieved. For reactive organometallic reagents, the contacting can be carried out under anhydrous inert atmosphere. The sorbent solid is non-reactive towards the organometallic reagent; consequently the solid is substantially anhydrous. For a solid such as silica including alkyl silicas, alumina, various forms of carbon such as charcoal or graphite, or a clay, drying can be achieved by warming the solid, under vacuum or under stream of anhydrous gas. The gas can be substantially free of oxygen or other reactive materials. The solid can be in powder form to facilitate mixing and to provide a favorable surface area / mass ratio for uptake of the solution.

When carried out on a relatively small scale, mixing can be carried out, for example, in a flask with a stir bar. For larger scale preparation, mixing can be conducted in any reactor fitted with mixing means, such as a paddle or the like. Depending upon the loading in terms of mmole/gm solid, the concentration of the organometallic reagent in the non-reactive solvent can be adjusted to achieve the target. A sufficient volume of the solvent can be used for homogeneous wetting of the solid, such that a homogeneous dispersion of the reagent in the solid is obtained following solvent removal.

The solvent can be removed by evaporation, such as under a vacuum, with heating, or both. Mixing can be carried out during the process of solvent removal to assist in complete evaporation. For removal of the solvent under a vacuum, the solvent should be of sufficient volatility such that evaporation of the solvent takes place under the conditions used. Solvents such as ethers, for example, diethyl ether, tetrahydrofuran, dioxane, diglyme, and the like, can be evaporated under soft vacuums at or somewhat above room temperature, i.e., about 22° C. Similarly, hydrocarbon solvents such as hexane and toluene can be removed under soft vacuum. By a soft vacuum is meant a vacuum of more than about 10 microns Hg. Removal of solvent can be complete, but in various embodiments, residual solvent can be present. For complete removal of solvent, the solid can be held under high vacuum, i.e., less than about 10 microns Hg, for a period of time, optionally with heating and/or stirring to facilitate solvent evaporation.

In physical form, the solid can be a flowable powder. The solid can be stirred or comminuted after removal of the solvent to achieve a target consistency or flowability. The solid can be transferred from vessel to vessel in the usual manner of handling of solid chemical reagents, e.g., with spatulas, pouring through funnels, on pieces of weighing paper, and the like. Special precautions such as inert atmosphere, glove boxes, or glove bags are not necessary, although the stabilized composition is preferably kept from contact with acids, liquid water or highly humid conditions. The composition can be stored in stoppered flasks and the like. The headspace of the flask can be filled with anhydrous inert gas such as nitrogen or (particularly for organolithium reagents) argon. The material can be stored at ambient temperature, or can be stored chilled. Upon rewarming, the vessel can be kept closed and/or under anhydrous inert atmosphere to prevent moisture condensation on the solid, which can decompose the organometallic reagent permeating the sorbent solid.

In various embodiments, the invention provides methods of using the stabilized organometallic reagent composition of the invention or prepared according to a method of the invention, such as in carrying out chemical reactions typical for the particular organometallic reagent.

An approximate concentration of the organometallic reagent in the sorbent solid can be calculated based upon an amount of a solution of known concentration of the reagent that is contacted with the sorbent solid in preparation of the sample For example, if a quantity, for example 20 mmole, of the organometallic reagent in a non-reactive solvent is contacted with 10 gms of sorbent solid, and the solvent is subsequently removed, an approximate concentration of 2 mmole/gm of solid is achieved.

Alternatively, a concentration can be calculated by contacting the stabilized organometallic composition with a known volume of an inert solvent, preferably with mixing, such that extraction of the organometallic reagent into the solvent is achieved. Then, the concentration in the liquid can be titrated by methods well known in the art for the particular organometallic reagent.

In various embodiments, for use as a reagent in carrying out organic synthesis, an appropriate quantity of the solid stabilized composition can be weighed into a reaction vessel, and then reacted with a reactant in a second non-reactive solvent. The second non-reactive solvent, i.e., the solvent in which a reaction using the inventive composition can be carried out, can be the same solvent or a different solvent as the non-reactive solvent used in preparation of the inventive composition. Once the organometallic reagent is redissolved in the solvent, the standard handling procedures for solutions of the particular organometallic reagent can be employed, e.g., inert atmosphere, septa and syringes, etc.

The solid can be filtered and washed with further non-reactive solvent, for example under inert atmosphere through a glass frit funnel, or alternatively a reactant can be added to the solution without further processing. The non-reactive solvent used to extract the reagent from the sorbent solid need not be the same non-reactive solvent used in the preparation of the stabilized composition. Any suitably non-reactive solvent in which the organometallic reagent has sufficient solubility can be used. Alternatively, the organometallic reagent can be extracted from the stabilized composition by a neat reactant provided the neat reactant is a liquid.

For example, if a Grignard reagent in stabilized form is used, the reagent can be dissolved and extracted from the sorbent solid, and the reactant added to the same reaction vessel. A reactant can be, for example, a carbonyl compound, e.g. cyclohexanone, with which it is desired to react the Grignard reagent to obtain the predicted reaction product. Or, the reactant can be any electrophilic compound suitable for reaction with a solution of a Grignard reagent. By embodiments of this method, the person of skill can obtain a target reaction product using the stabilized composition such as could have been obtained using a standard, commercial solution of the organometallic reagent, but with much simpler handling procedures. As it is possible to prepare larger quantities of the stabilized organometallic reagent composition in advance and store the larger quantity, all that is required to carry out a desired reaction is to weigh the stabilized composition into the reaction vessel, add non-reactive solvent, add reactant, and allow the reaction to proceed. This avoids the tedious and time-consuming repetitive process of either preparing the Grignard reagent each time it is to be used from magnesium metal and a halo-organic compound, or storing the reactive, unstable, and potentially dangerously pyrophoric solution form of the reagent.

The characteristic reactions of organometallic reagents with reactants can be carried out using the stabilized composition of the invention. For example, the organometallic compound can be an organozinc reagent and the reactant any electrophilic compound suitable for a reaction with a solution organozinc compound. For example, if the organozinc reagent is of the type RZnX, the reactant can be an electrophilic reactant of the type suitable for reaction with RZnX in solution, wherein X is an anionic counterion, for example, a halide ion. For example, if the organozinc reagent is of the type R₂Zn, the reactant can be an electrophilic reactant of the type suitable for reaction with R₂Zn in solution. For example, if the organozinc reagent is of the type R₃ZnM, the reactant can be an electrophilic reactant of the type suitable for reaction with R₃ZnM in solution, wherein M is a suitable cationic counterion for a zincate, for example, a lithium or a sodium ion. Or, the organometallic compound can be an organolithium reagent and the reactant an organic compound having an acidic proton capable of being abstracted by the organolithium reagent to form a carbanion. Or, the organometallic compound can be an organocopper reagent and the reactant an α,β-unsaturated carbonyl compound.

If desired, additional non-reactive solvents can be added to the reaction mixture, or a mixture of non-reactive solvents can be used to extract the organometallic reagent from the stabilized composition. Suitable solvents include ethers, hydrocarbons, and others apparent to those of skill in the art.

Co-reactants can also be added in the course of the reaction. For example, if the stabilized composition comprises an organolithium reagent, and it is desired to form a lithium amide base to carry out a reaction, the precursor amine, such as diisopropylamine or 2,2,6,6-tetramethylpiperidine, can be added to the extraction solvent before or after the organometallic reagent is extracted from the stabilized composition in the course of conducting the reaction.

### EXAMPLES

### Example 1

### Reformatsky Reaction

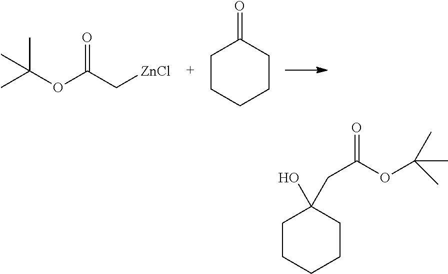

The organozinc reagent 2-tert-butoxy-2-oxoethylzinc chloride was loaded onto C8-silica gel at a ratio of 2mmol/gram of C8-silica gel, (C8-silica gel, spherical encapped, 70A, 40-75 um, Supplier Sorbent, Cat#62526):

7.5 grams of silica gel-C8 was weighed out into a dry 100 mL round bottom flask containing a stir bar under argon. The flask was then gently warmed with a heating mantle under a vacuum for 5 hours to dry the silica gel. The flask was then placed under an argon gas atmosphere. Then, 25 mL of 2-tert-Butoxy-2-oxoethylzinc chloride @0.55M in Diethyl Ether was added to the reaction flask that contained the silica gel while stirring. The reaction warmed slightly. The reaction stirred 20 minutes before the solvent was removed by vacuum. Material had been dried under vacuum for 2 hours. I was left with a white powder as well as a hard layer of white solid on the bottom of the flask. This flask was put under argon atmosphere and then store at 0° C. for two days.

The flask was then removed from the freezer and 30 mL of anhydrous diethyl ether was added to it with stirring. To this slurry, 1.5 grams of cyclohexanone was added. The reaction was allowed to stir for 1 hour, then an aliquot was removed and worked up with dilute HCl and ether.

Product: G.C. analysis,
17.3% hydrolyzed organozinc
28.5% cyclohexanone
51.4% product

### Control:

The equivalent reaction was repeated using the same organozinc Reformatsky reagent in solution on a 2.75 mmol scale without the silica gel.

G.C. analysis,
7.5% hydrolyzed organozinc
15.7% cyclohexanone
74.0% product

### Example 2

### Negishi Coupling

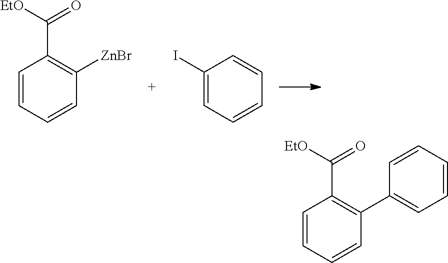

Into a 50 mL flask was added Silica gel (2.5 g, Sorbent Technology, cat. #62526-01) and then pumped down under high vacuum pressure for 30 min. Next, 10 mL of 2-(ethoxycarbonyl)phenylzinc bromide (0.5 M in THF, 5 mmol) was added with a syringe at room temperature. After being stirred for 30 min, the solvent was removed under high vacuum pressure.

Then, to the organozinc reagent on silica gel was added 10 mL of fresh THF, followed by Pd[P(P)₃]₄ (0.06 g, 1 mol %) in 5.0 mL of THF was added. Then, iodobenzene (0.82 g, 4 mmol) was added neat via a syringe at room temperature while being stirred. After being stirred for 24 h, the reaction mixture was filtered through filter paper, the filtrate quenched with 3 M HCl solution and then extracted with ether. Combined organics were washed with saturated Na₂S₂O₃ solution, and brine, then dried over MgSO₄. A column chromatography (10% EtOAc/90% Heptane) gave 0.68 g (75% isolated yield) of ethyl 2-phenylbenzoate.

### Example 3

### Coupling of Organozinc and Benzoyl Chloride

Into a 50 mL flask was added Silica gel (2.5 g, Sorbent Technology) and then pumped down under high vacuum pressure for 30 min. Next, 20 mL of 3-ethoxy-3-oxopropylzinc bromide (0.5 M in THF, 10 mmol) was added into the flask via a syringe at rt. After being stirred at rt for 30 min, the solvent was removed under high vacuum pressure affording a light gray powder.

Into the flask containing the organozinc reagent on silica gel was added 20 mL of fresh THF. A mixture of CuI (0.19 g, 10 mol %) and LiCl (0.09g, 20 mol %) in 5.0 mL of THF was also added. Then, benzoyl chloride (1.12 g, 8 mmol) was added neat via a syringe at rt while being stirred. After being stirred at rt for 3 h, the reaction mixture was filtered through a filter paper. The filtrate was quenched with 3 M HCl solution and then extracted with ether. Combined organics were washed with 7% NH₄OH solution, saturated NaHCO₃ solution, and brine. Dried over MgSO₄. A column chromatography (10% EtOAc/90% Heptane) gave 1.15 g (70% isolated yield) of 4-oxo-4-phenylbutyric acid ethyl ester.

### Example 4

### Grignard Reaction

Into a 50 mL flask was added Silica gel (5.0 g, Sorbent Technology) and then pumped down under high vacuum pressure for 30 min. Next, 20 mL of 4-methylphenylmagnesium bromide (0.5 M in THF, 10 mmol) was added into the flask via a syringe at rt. After being stirred at rt for 30 min, the solvent was removed under high vacuum pressure affording a white powder. Into the flask containing the Grignard on silics gel was added 20 mL of fresh THF. Then, benzoyl chloride (1.12 g, 8 mmol) was added neat via a syringe at rt while being stirred. After being stirred at rt for 30 min, the reaction mixture was filtered through a filter paper. The filtrate was quenched with 3 M HCl solution and then extracted with ether. Combined organics were washed with saturated NaHCO₃, and brine. A column chromatography (10% EtOAc/90% Heptane) gave 1.25 g (80% isolated yield) of 4-methybenzophenone.

While the invention has been described and exemplified in sufficient detail for those skilled in this art to make and use it, various alternatives, modifications, and improvements will be apparent to those skilled in the art without departing from the spirit and scope of the claims.

All patents and publications referred to herein are incorporated by reference herein to the same extent as if each individual publication was specifically and individually indicated to be incorporated by reference in its entirety.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A stabilized organometallic reagent composition comprising a non-reactive sorbent solid permeated with an organometallic compound wherein the organometallic compound is an organozinc compound or an organomagnesium compound.

2. The composition of claim 1 wherein the organometallic reagent is present at a loading of about 1 mmole per gram of solid to about 8 mmole per gram of solid.

3. The composition of claim 1 wherein the organometallic reagent is present at a loading of about 2 mmole per gram of solid to about 4 mmole per gram of solid.

4. The composition of claim 1 wherein the sorbent solid is a porous solid.

5. The composition of claim 1 wherein the composition further comprises a non-reactive solvent in which the organometallic compound is soluble.

6. The composition of claim 5 wherein the non-reactive solvent comprises an ether or a hydrocarbon, or any mixture thereof.

7. The composition of claim 5 wherein the non-reactive solvent comprises diethyl ether, tetrahydrofuran, 1,4-dioxane, glyme, diglyme, pentane, hexane, octanes, benzene, toluene, or xylenes, or any mixture thereof.

8. The composition of claim 1 wherein the sorbent solid comprises silica, an alkylated silica, alumina, forms of carbon such as charcoal or graphite, or a clay.

9. The composition of claim 8 wherein the alkylated silica comprises C8-silica or C 18-silica.

10. The composition of claim 1 wherein the organometallic compound comprises an, organomagnesium, or organozinc reagent.

11. The composition of claim 1 wherein the organometallic compound is a Grignard reagent, a Reformatsky reagent, a dialkyl zinc reagent, an alkyl zinc halide reagent, a diaryl zinc reagent, a trialkyl zincate reagent or, a triaryl zincate reagent.

12. The composition of claim 1 wherein the stabilized organometallic reagent composition is a particulate material suitable for handling in air.

13. The composition of claim 1 wherein the stabilized organometallic reagent composition is less pyrophoric than is the organometallic compound in pure form or the organometallic compound in solution, or both.

14. A method of preparation of the composition of claim 1, comprising contacting the sorbent solid with a solution of the organometallic compound in the non-reactive solvent, then, removing the solvent.

15. The method of claim 14 wherein removing the solvent comprises evaporating the solvent under a vacuum.

16. A method of using the composition of claim 1 or a composition prepared by the method of claim 14, comprising contacting the composition with one or more reactants, optionally in a second non-reactive solvent, such that the organometallic compound undergoes a chemical reaction with the one or more reactants to yield a reaction product.

17. The method of claim 16 wherein the second non-reactive solvent is the same as the non-reactive solvent.

18. The method of claim 16 wherein the organometallic compound is a Grignard reagent and the reactant is an electrophilic compound suitable for reaction with a solution of a Grignard reagent.

19. The method of claim 16 wherein the organometallic compound is an organozinc reagent of the type RZnX and the reactant is an electrophilic reactant of the type suitable for reaction with RZnX in solution, wherein X is an anionic counterion.

20. The method of claim 16 wherein the organometallic compound is an organozinc reagent of the type R₂Zn and the reactant is an electrophilic reactant of the type suitable for reaction with R₂Zn in solution.

21. The method of claim 16 wherein the organometallic compound is an organozinc reagent of the type R₃ZnM and the reactant is an electrophilic reactant of the type suitable for reaction with R₃ZnM in solution, wherein M is a cationic counterion.

22. (canceled)

23. (canceled)

24. The method of claim 16 wherein the contacting occurs in the second non-reactive solvent.

25. The method of claim 16 wherein the organometallic compound is, prior to addition of the reactant, extracted at least in part from the sorbent solid by contacting with the second non-reactive solvent.

26. The method of claim 25 further comprising addition of a co-reactant to the reactant.

27. (canceled)

28. (canceled)
